(19) United States
(12) Patent Application Publication
(10) Pub. No.: US 2003/0005675 A1
(43) Pub. Date: Jan. 9, 2003

(54) Wheeled support for vegetation trimmer

(76) Inventor: Michael Baker, Vancouver (CA)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/907,217

(22) Filed: Jul. 17, 2001

(30) Foreign Application Priority Data
Dec. 12, 2000 (CA) 2,328,117

(51) Int. Cl. A01D 34/64

(52) U.S. Cl. 56/16.7

(57) ABSTRACT

A wheeled support for a vegetation trimmer which includes a first body and a second body. The first body has a wheel end and a clamp end. A first wheel is positioned at the wheel end of the first body. The second body also has a wheel end and a clamp end. a second wheel is positioned at the wheel end of the second body. A pivotal assembly extends between and connects the wheel end of the first body and the wheel end of the second body. This pivotal assembly leaves a vegetation trimmer receiving space between the first body and the second body. A clamp clamps together the clamp end of the first body and the clamp end of the second body, thereby clamping a body of a vegetation trimmer in the vegetation trimmer receiving space between the first body and the second body.

### FIELD OF THE INVENTION

The present invention relates to a wheeled support for a vegetation trimmer and, in particular, a vegetation trimmer that uses a rotating line to sever vegetation.

### BACKGROUND OF THE INVENTION

There are currently being manufactured a number of wheeled supports that are adapted to support various makes and models of vegetation trimmers. Examples of such wheeled supports are disclosed in the following U.S. Pat. Nos.: 4,442,659; 4,914,899; 4,981,012; 5,095,687; 5,317,807; 5,626,006.

### SUMMARY OF THE INVENTION

The present invention relates to an alternative configuration of wheeled support.

According to the present invention there is provided a wheeled support for a vegetation trimmer which includes a first body and a second body. The first body has a wheel end and a clamp end. A first wheel is positioned at the wheel end of the first body. The second body also has a wheel end and a clamp end. a second wheel is positioned at the wheel end of the second body. A pivotal assembly extends between and connects the wheel end of the first body and the wheel end of the second body. This pivotal assembly leaves a vegetation trimmer receiving space between the first body and the second body. A clamp clamps together the clamp end of the first body and the clamp end of the second body, thereby clamping a body of a vegetation trimmer in the vegetation trimmer receiving space between the first body and the second body.

The wheeled support, as described above, can easily and rapidly be positioned on a vegetation trimmer. By positioning a body of the vegetation trimmer in the vegetation trimmer receiving space and clamping the vegetation trimmer in place.

Although beneficial results may be obtained through the use of the vegetation trimmer, as described above, there are numerous different makes and models of vegetation trimmer having bodies of differing dimension. Even more beneficial results may be, therefore, obtained when the vegetation trimmer receiving space is adjustable in size by altering either the number or the size of links that form part of the pivotal assembly.

Although beneficial results may be obtained through the use of the vegetation trimmer, as described above, it is important that the vegetation trimmer be held securely in positioned within the vegetation trimmer receiving space. Even more beneficial results may, therefore, be obtained when the first body has a first engagement profile extending into the vegetation trimmer receiving space and the second body has a second engagement profile extending into the vegetation trimmer receiving space, the first engagement profile and the second engagement profile being adapted to engage a vegetation trimmer positioned in the vegetation trimmer receiving space.

Although beneficial results may be obtained through the use of the vegetation trimmer, as described above, the positioning requirements for the engagement profiles differs with various makes and models of vegetation trimmer. Even more beneficial results may, therefore, be obtained when the first engagement profile is positioned on a first repositionable mounting member and the second engagement profile is positioned on a second repositionable mounting member. The mounting members may be repositioned, as required, to ensure proper engagement with various makes and models of vegetation trimmer. There are various ways in which this can be done. With preferred embodiment, which will hereinafter be described in more detail, the first repositionable mounting member has a male mounting projection and the first body has several alternative female mounting receptacles which are adapted to receive the male mounting projection of the first repositionable mounting member. Similarly, the second repositionable mounting member has a male mounting projection and the second body has several alternative female mounting receptacles which are adapted to receive the male mounting projection of the second repositionable mounting member.

There are various forms of clamp that can be used to hold the clamp end of the first body and the clamp end of the second body together. In the preferred embodiment, the clamp includes a bolt which extends through a first aperture at the clamp end of the first body and a second aperture at the clamp end of the second body.

Although beneficial results may be obtained through the use of the vegetation trimmer, as described above, when the first body and the second body are clamped around vegetation trimmer bodies of differing dimensions, the angular relationship of the first aperture and the second aperture changes, so that they may not be axially aligned. Even more beneficial results may, therefore, be obtained when one or both of the first aperture and the second aperture extend through a ball mounting, such that by partial rotation of the ball mounting the relative positioning of the first aperture and the second aperture is adjustable to maintain axial alignment.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is an exploded side elevation view, partially in section, of a wheeled support constructed in accordance with the teachings of the present invention.

FIG. 2 is a top plan view of the wheeled support illustrated in FIG. 1.

FIG. 3 is a front elevation view, partially in section, of a wheeled support for a vegetation trimmer constructed in accordance with the teachings of the present invention supporting a wide bodied vegetation trimmer.

FIG. 4 is a top plan view of the wheeled support with wide bodied vegetation trimmer illustrated in FIG. 3.

FIG. 5 is a side elevation view of the wheeled support with wide bodied vegetation trimmer illustrated in FIG. 3.

FIG. 6 is a front elevation view, partially in section, of a wheeled support constructed in accordance with the teachings of the present invention supporting a narrow bodied vegetation trimmer.

FIG. 7 is a top plan view of the wheeled support with narrow bodied vegetation trimmer illustrated in FIG. 6.

FIG. 8 is a side elevation view of the wheeled support with narrow bodied vegetation trimmer illustrated in FIG. 6.

### DETAILED DESCRIPTION OF THE PREFERRED EMBODIMENT

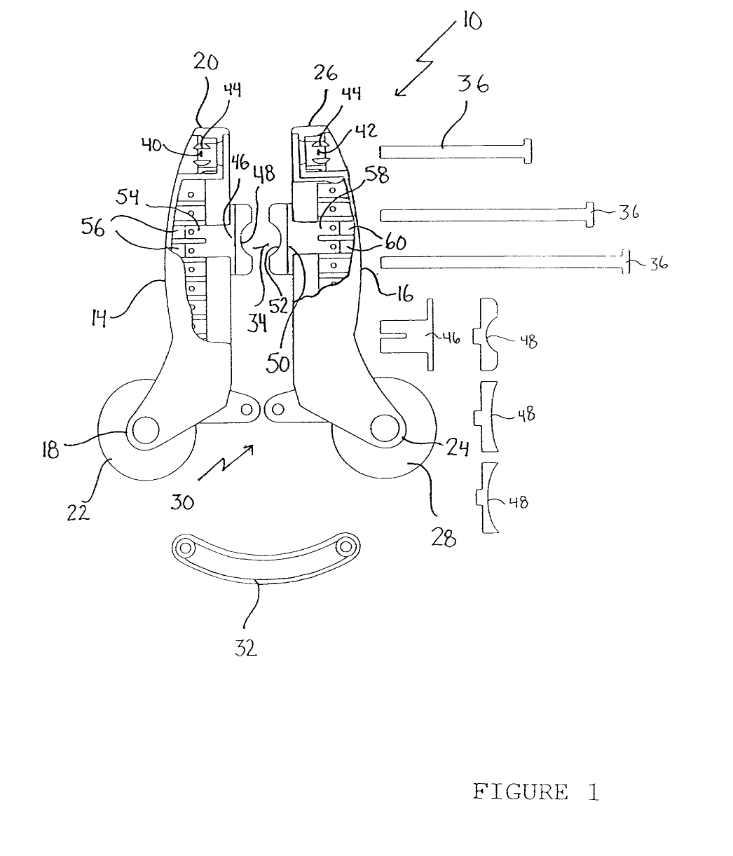

The preferred embodiment, a wheeled support for a vegetation trimmer generally identified by reference numeral 10, will now be described with reference to FIGS. 1 through 8 .

Structure and Relationship of Parts

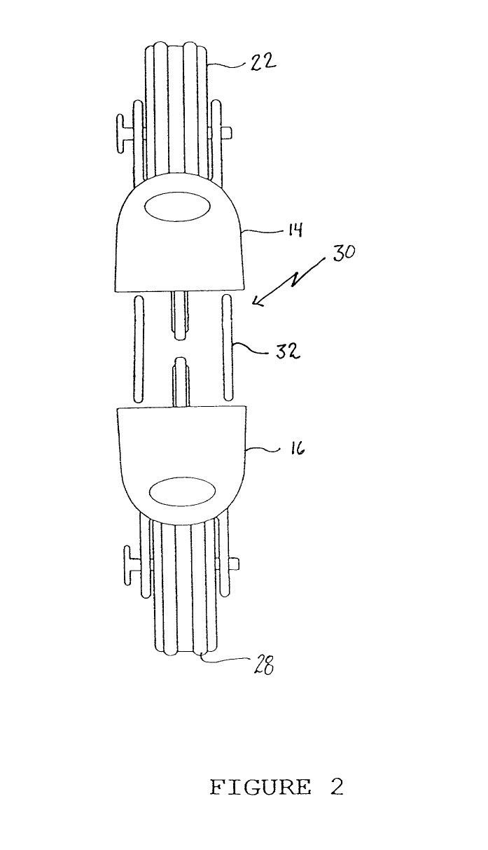

Referring to FIG. 1, there is provided a wheeled support 10 for a vegetation trimmer generally referenced by numeral 12. Referring to FIG. 2, wheeled support 10 includes a first body 14 and a second body 16. Referring to FIG. 1, first body 14 has a wheel end 18 and a clamp end 20. A first wheel 22 is positioned at wheel end 18 of first body 14. Second body 16 also has a wheel end 24 and a clamp end 26. A second wheel 28 is positioned at wheel end 24 of second body 16.

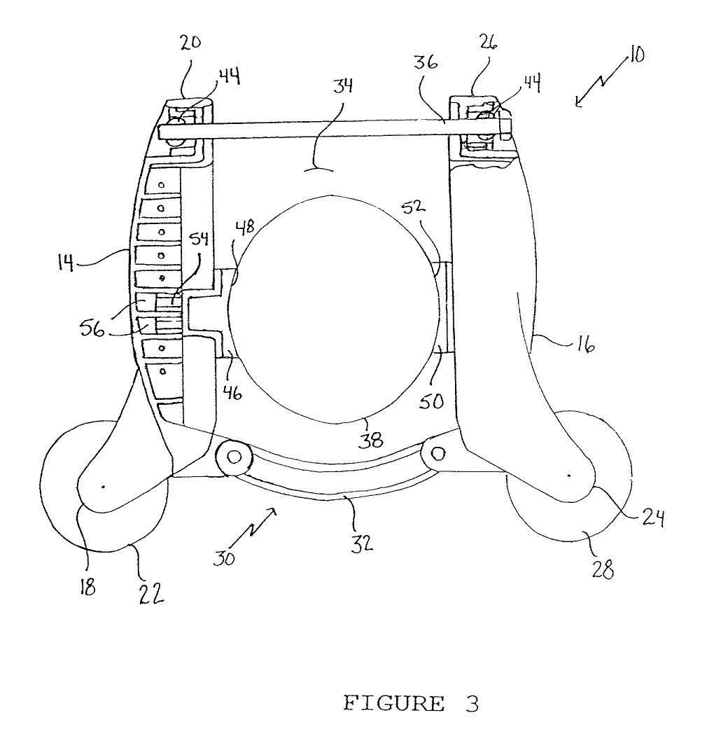

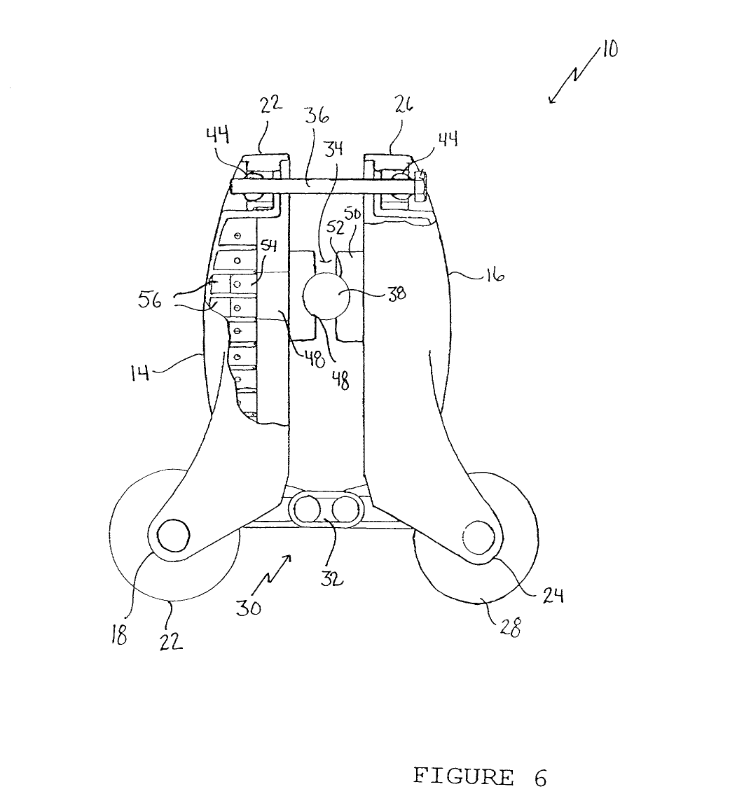

A pivotal assembly generally referenced by numeral 30 extends between wheel end 18 of first body 14 and wheel end 24 of second body 16. Pivotal assembly 30 includes a link 32 which connects wheel end 18 of first body 14 with wheel end 24 of second body 16. Pivotal assembly 30 leaves a vegetation trimmer receiving space 34 between first body 14 and second body 16. Referring to FIGS. 3 and 6, vegetation trimmer receiving space 34 can be adjusted in size by altering the size or number of links 32 in pivotal assembly 30. Referring to FIG. 3, link 32 is larger where a larger size of vegetation trimmer receiving space 34 is required, while in FIG. 2, link 32 that is smaller is used to provide a smaller size of vegetation trimmer receiving space 34.

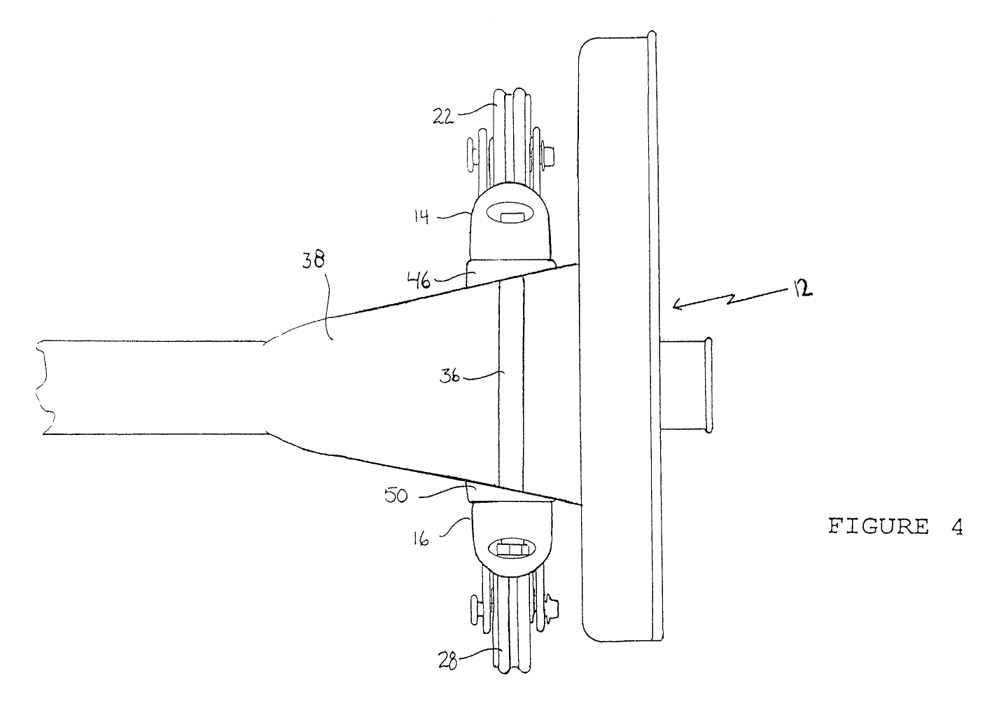

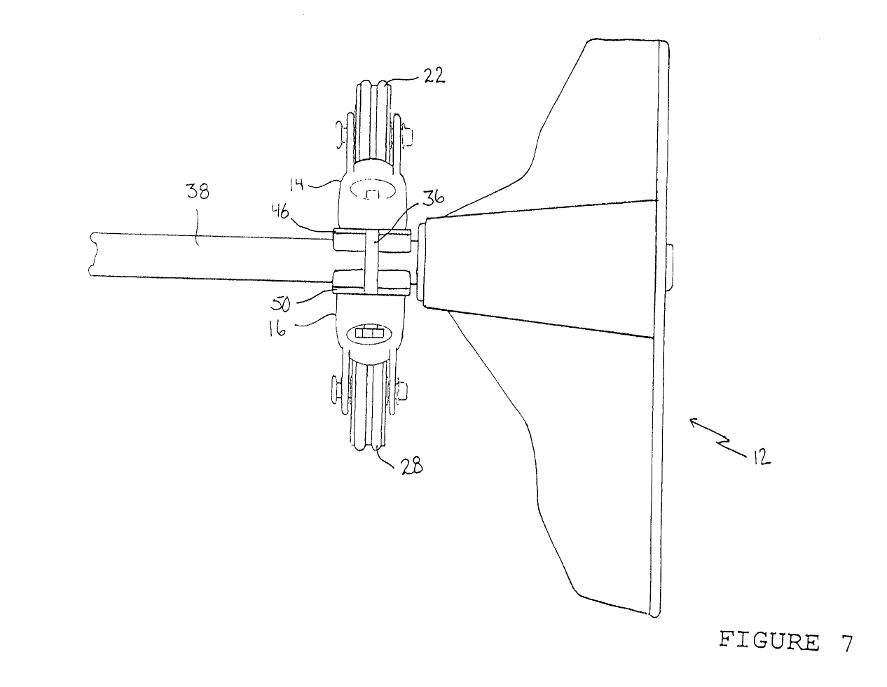

A clamp clamps together clamp end 20 of first body 14 and clamp end 26 of second body 16, thereby clamping a body 38 of vegetation trimmer 12 in vegetation trimmer receiving space 34 between first body 14 and second body 16. In the illustrated embodiment, the clamp is a bolt 36 which extends through a first aperture 40 at clamp end 20 of first body 14 and a second aperture 42 at clamp end 26 of second body 16. It will be appreciated that other clamping means will also function. Referring to FIGS. 4 and 7, bolts 36 used may differ in length depending on the size of vegetation trimmer receiving space 34 that is required to accommodate different makes and models of vegetation trimmer 12. Referring to FIG. 1, first aperture 40 and second aperture 42 extend through ball mountings 44, such that by partial rotation of ball mounting 44, the relative positioning of first aperture 40 and second aperture 42 is adjustable to maintain axial alignment.

A first repositionable mounting member 46 with a first engagement profile 48 is removably mounted to first body 14. First engagement profile 48 extends into vegetation trimmer receiving space 34. A second repositionable mounting member 50 with a second engagement profile 52 is removably mounted to second body 16. Second engagement profile 52 also extends into vegetation trimmer receiving space 34. First engagement profile 48 and second engagement profile 52 are adapted to engage body 38 of vegetation trimmer 12 positioned in vegetation trimmer receiving space 34. First engagement profile 48 and second engagement profile 52 can come in a variety of dimensions and shapes to accommodate the differences in size and dimension of bodies 38 of the various makes and models of vegetation trimmers 12. First repositionable mounting member 46 has a male mounting projection 54 and first body 14 has several alternative female mounting receptacles 56 which are adapted to receive male mounting projection 54 of first repositionable mounting member 56. Second repositionable mounting member 50 also has a male mounting projection 58 and second body 16 has several alternative female mounting receptacles 60 which are adapted to receive male mounting projection 58 of second repositionable mounting member 50.

Operation

The use and operation of wheeled support 10 for vegetation trimmer, will now be described with reference to FIGS. 1 through 8. Referring to FIG. 4, wheeled support 10 can be easily and rapidly positioned on vegetation trimmer 12. Because there are numerous different makes and models of vegetation trimmers 12 that have bodies 38 of differing dimensions, vegetation trimmer receiving space 34 of wheeled support 10 must first be adjusted to a suitable size by selecting an appropriate size of 32 to form part of pivotal assembly 30. Referring to FIG. 3, if body 38 is of a larger size, then a larger link 32 is used. Referring to FIG. 6, if body 38 is of a smaller size, then a smaller link 32 is used.

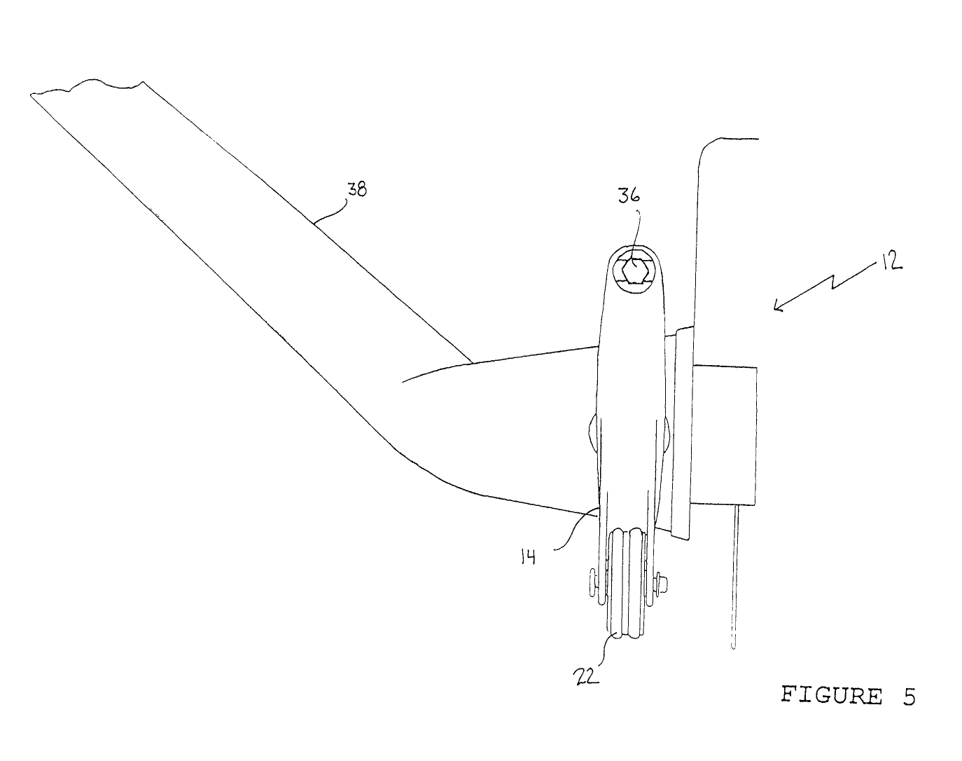

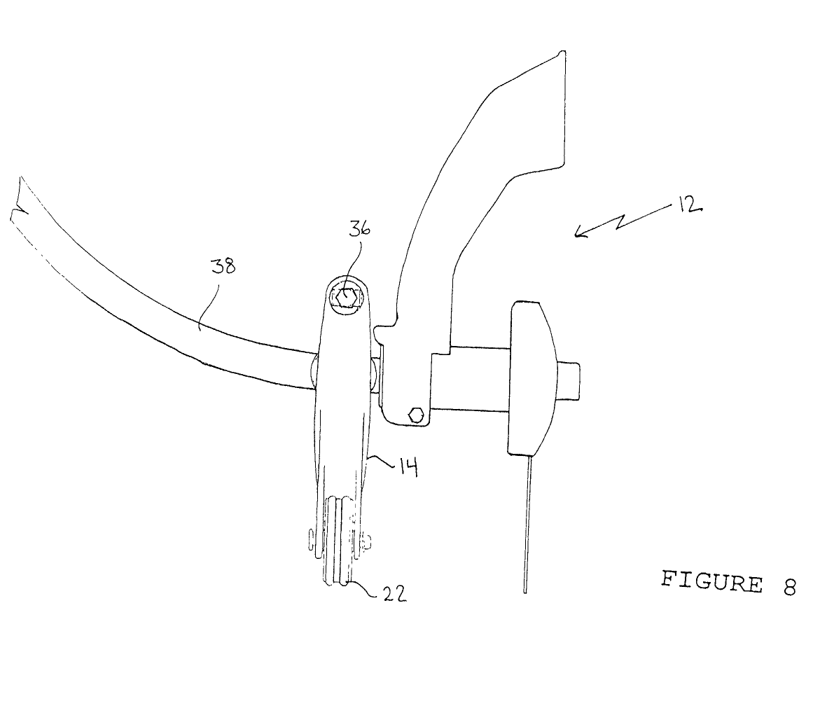

Referring to FIG. 1, once the size of vegetation trimmer receiving space 34 has been adjusted to receive body 38 of vegetation trimmer 12, first engagement profile 48 and second engagement profile 52 are repositioned, as required, to ensure proper engagement with body 38 of the particular make and models of vegetation trimmer 12. First engagement profile 48 is repositioned by inserting male mounting projection 54 of first repositionable mounting member 46 into any of several alternative female mounting receptacles 56 on first body 14 of wheeled support 10. Second engagement profile 52 is similarly repositioned on second body 16. Body 38 of vegetation trimmer 12 is then positioned in vegetation trimmer receiving space 34 and clamp end 20 of first body 14 and clamp end 26 of second body 16 are clamped together with bolt 36 so that first engagement profile 48 and second engagement profile 52 are securely engaged with body 38 of vegetation trimmer 12. Referring to FIGS. 7 and 8, a short bolt 36 is used when body 38 of vegetation trimmer 12 is of a smaller size. Referring to FIGS. 4 and 5, a longer bolt 36 is used when body 38 of vegetation trimmer 12 is of a larger size. Referring to FIGS. 3 and 6, when first body 14 and second body 16 of wheeled support 10 are clamped around the differing dimensions of bodies 38 of vegetation trimmers 12, the angular relationship of first aperture 40 and second aperture 42 changes so that first aperture 40 and second aperture 42 may not be axially aligned. By partial rotation of ball mountings 44, the relative positioning of first aperture 40 and second aperture 42 is adjusted to maintain axial alignment so that bolt 36 can properly extend through first aperture 40 and second aperture 42 for the purpose of clamping first body 14 and second body 16 together. When wheeled support 10 has been positioned on vegetation trimmer 12, wheeled support 10 steadies and supports vegetation trimmer 12 as vegetation trimmer 12 is rolled around sidewalks, driveways and gardens thereby permitting vegetation trimmer 12 to trim straighter edges.

It will be apparent to one skilled in the art that wheeled support 10 is capable of securely supporting a vegetation trimmer 12. More importantly, it will be apparent to one skilled in the art the advantage that wheeled support 10 has over the prior art in being able to easily accommodate vegetation trimmers 12 made by different manufacturers that have different bodies 38.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property Or privilege is claimed are defined as follows:

1. A wheeled support for a vegetation trimmer, comprising:
a first body having a wheel end and a clamp end;
a first wheel positioned at the wheel end of the first body;
a second body having a wheel end and a clamp end;
a second wheel positioned at the wheel end of the second body;
a pivotal assembly between the wheel end of the first body and the wheel end of the second body, the pivotal assembly leaving a vegetation trimmer receiving space between the first body and the second body;
a clamp clamping together the clamp end of the first body and the clamp end of the second body, thereby clamping a body of a vegetation trimmer in the vegetation trimmer receiving space between the first body and the second body.

2. The wheeled support as defined in claim 1, wherein the vegetation trimmer receiving space is adjustable in size by altering one of a number and a size of links in the pivotal assembly.

3. The wheeled support as defined in claim 1, wherein the first body has a first engagement profile extending into the vegetation trimmer receiving space and the second body has a second engagement profile extending into the vegetation trimmer receiving space, the first engagement profile and the second engagement profile being adapted to engage a vegetation trimmer positioned in the vegetation trimmer receiving space.

4. The wheeled support as defined in claim 3, wherein the first engagement profile is positioned on a first repositionable mounting member and the second engagement profile is positioned on a second repositionable mounting member.

5. The wheeled support as defined in claim 4, wherein the first repositionable mounting member has a male mounting projection and the first body has several alternative female mounting receptacles which are adapted to receive the male mounting projection of the first repositionable mounting member; and
the second repositionable mounting member has a male mounting projection and the second body has several alternative female mounting receptacles which are adapted to receive the male mounting projection of the second repositionable mounting member.

6. The wheeled support as defined in claim 1, wherein the clamp is a bolt which extends through a first aperture at the clamp end of the first body and a second aperture at the clamp end of the second body.

7. The wheeled support as defined in claim 6, wherein at least one of the first aperture and the second aperture extend through a ball mounting, such that by partial rotation of the ball mounting the relative positioning of the first aperture and the second aperture is adjustable to maintain axial alignment.

8. A wheeled support for a vegetation trimmer, comprising:
a first body having a wheel end and a clamp end;
a first wheel positioned at the wheel end of the first body;
a second body having a wheel end and a clamp end;
a second wheel positioned at the wheel end of the second body;
a pivotal assembly between the wheel end of the first body and the wheel end of the second body, the pivotal assembly including a link and leaving a vegetation trimmer receiving space between the first body and the second body, the vegetation trimmer receiving space being adjustable in size by altering the size of the link in the pivotal assembly;
a clamp clamping together the clamp end of the first body and the clamp end of the second body, thereby clamping a body of a vegetation trimmer in the vegetation trimmer receiving space between the first body and the second body, the clamp being a bolt which extends through a first aperture at the clamp end of the first body and a second aperture at the clamp end of the second body.;
a first repositionable mounting member having a first engagement profile removably mounted to the first body, the first engagement profile extending into the vegetation trimmer receiving space;
a second repositionable mounting member having a second engagement profile removably mounted to the second body, the second engagement profile extending into the vegetation trimmer receiving space, the first engagement profile and the second engagement profile being adapted to engage a vegetation trimmer positioned in the vegetation trimmer receiving space.

9. The wheeled support as defined in claim 8, wherein the first repositionable mounting member has a male mounting projection and the first body has several alternative female mounting receptacles which are adapted to receive the male mounting projection of the first repositionable mounting member; and
the second repositionable mounting member has a male mounting projection and the second body has several alternative female mounting receptacles which are adapted to receive the male mounting projection of the second repositionable mounting member.

10. The wheeled support as defined in claim 8, wherein at least one of the first aperture and the second aperture extend through a ball mounting, such that by partial rotation of the ball mounting the relative positioning of the first aperture and the second aperture is adjustable to maintain axial alignment.

11. The wheeled support as defined in claim 8, wherein a variety of alternative interchangeable engagement profiles are provided for each of the first engagement profile of the first repositionable mounting member and the second engagement profile of the second repositionable mounting member.

12. A wheeled support for a vegetation trimmer, comprising:
a first body having a wheel end and a clamp end;
a first wheel positioned at the wheel end of the first body;
a second body having a wheel end and a clamp end;
a second wheel positioned at the wheel end of the second body;
a pivotal assembly between the wheel end of the first body and the wheel end of the second body, the pivotal assembly including a link and leaving a vegetation trimmer receiving space between the first body and the second body, the vegetation trimmer receiving space being adjustable in size by altering the size of the link in the pivotal assembly;
a clamp clamping together the clamp end of the first body and the clamp end of the second body, thereby clamping a body of a vegetation trimmer in the vegetation trimmer receiving space between the first body and the second body, the clamp being a bolt which extends through a first aperture at the clamp end of the first body and a second aperture at the clamp end of the second body, the first aperture and the second aperture extending through ball mountings, such that by partial rotation of the ball mounting the relative positioning of the first aperture and the second aperture is adjustable to maintain axial alignment;
a first repositionable mounting member having a first engagement profile removably mounted to the first body, the first engagement profile extending into the vegetation trimmer receiving space;
a second repositionable mounting member having a second engagement profile removably mounted to the second body, the second engagement profile extending into the vegetation trimmer receiving space, the first engagement profile and the second engagement profile being adapted to engage a vegetation trimmer positioned in the vegetation trimmer receiving space, the first repositionable mounting member having a male mounting projection and the first body having several alternative female mounting receptacles which are adapted to receive the male mounting projection of the first repositionable mounting member, the second repositionable mounting member having a male mounting projection and the second body having several alternative female mounting receptacles which are adapted to receive the male mounting projection of the second repositionable mounting member.
